(19) United States
(12) Patent Application Publication
(10) Pub. No.: US 2010/0265834 A1
(43) Pub. Date: Oct. 21, 2010

(54) VARIABLE LATENCY JITTER BUFFER BASED UPON CONVERSATIONAL DYNAMICS

(75) Inventors: Paul Roller Michaelis, Louisville, CO (US); David Mohler, Arvada, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/426,023

(22) Filed: Apr. 17, 2009

(51) Int. Cl. H04L 12/26

(52) U.S. Cl. 370/252

(57) ABSTRACT

Methods, devices, and systems for balancing latency and voice quality during a communication session are provided. More specifically, mechanisms for monitoring parameters indicative of conversational dynamics and adjusting jitter buffer size based thereon are described. This allows latency to increase if the conversation is not highly interactive and decrease if a more interactive conversation is desired.

### FIELD OF THE INVENTION

The invention relates generally to communications and more specifically to Voice over Internet Protocol communications.

### BACKGROUND

Traditional analog audio communications transmit audio information across a communication network as a continuous stream. In contrast to analog audio communications, packet-based communications, such as Voice over Internet Protocol (VoIP), convert analog audio data received at a microphone of a communication device into digital audio data. The digital data or digital voice samples are then formed into separate packets for transmission across a communication network to a receiving communication device. The receiving communication device then reassembles the packets and the digitally coded audio back into a continuous audio stream. The audio stream may then be presented to a user of the receiving communication device.

While the use of packet-based communications does have many advantages, it also introduces several challenges. For example, sometimes voice packets may not be delivered to their destination (i.e., the receiving communication device) as a smooth, non-varying stream. Often packets from the same audio stream travel different paths as they move toward their destination. In other words, packet routing is usually not based on its association with a particular audio stream. Factors such as network congestion or poor routing decisions can cause some packets to be delivered more slowly than other packets. In some cases, the delay of some packets with respect to others can be so extreme that the packets are delivered out-of-order. For this reason, receiving communication devices incorporate a jitter buffer, the purpose of which is to compensate for the inconsistent delivery times and potentially out-of-order arrival of voice packets.

A jitter buffer is a hardware device or software process that reduces jitter caused by transmission delays. As the jitter buffer receives packets, it writes them into memory in the order in which they were created by the transmitting system. (The sequence in which the packets were created by the transmitting system is determinable by examining the packet header, which will contain information such as a sequence number or time-of-creation.) Packets are read out in proper sequence at the earliest possible time. In other words, packets can be re-sequenced when out of order and are re-timed based on a local clock controlling a read pointer. The maximum delay, the slowest-delivered packet versus the fastest that can be countered by a jitter buffer is equal to the buffering delay introduced before starting the play-out of the audio stream.

A problem with jitter buffers is that their operation adds latency (i.e., the amount of time that elapses between when a word is spoken and when it is heard). When latency exceeds about 200 ms, interactive conversations can become awkward. This is because latency greater than this amount makes it difficult to time one's interjections and interruptions and often causes people to talk simultaneously without meaning to. For this reason, it has been felt that there is no value associated with having a digital telephone, such as a VoIP telephone, wait longer than approximately 200 ms for delayed packets to arrive.

If a packet does not arrive prior to its turn to be played (i.e., within about 200 ms after it was transmitted), then the receiving communication device will rely on packet loss concealment techniques that attempt to hide the absence of the missing packet when the audio stream is presented to the listener. One type of packet loss concealment algorithm replaces the lost audio data with “comfort noise.” Other types of packet loss concealment algorithms attempt to interpolate between the successfully received audio packets surrounding the dropped audio packet.

Rather than employing packet loss concealment techniques, other communication systems utilize the Transmission Control Protocol (TCP) to maintain the integrity of communications. In TCP-based systems, a receiving communication device will request a retransmission if a packet is determined to be missing. In this scenario, there can be a variation in how long the receiving communication device waits for a delayed packet before requesting a retransmission (as opposed to how long it waits before utilizing packet loss concealment).

Although these algorithms are useful, primarily because they help avoid annoying clicks and pops that would be heard if the techniques were not used, the deleterious effect of packet loss on speech intelligibility is unquestionable.

### SUMMARY

Despite the audio quality benefits associated with waiting for delayed packets to arrive, the overriding factor in digital telephony and telephone design has been the desire to keep latencies at a level appropriate for highly interactive conversations. A shortcoming with this approach is that, for conversations that are not highly interactive, there is not a compelling need to keep latencies to less than about 200 ms. Keeping in mind that voice quality is higher when there is a decreased need for packet loss concealment, there are conversational conditions under which it may be sensible—if not desirable—to accept a greater degree of latency in exchange for improved voice quality. In other words, if the characteristics of the conversation dictate that latencies do not need to be held to a minimum threshold, then it may be desirable to have the receiving communication device wait a bit longer than normal for delayed packets to arrive.

Some prior art devices are designed to wait a fixed amount of time, usually between about 50 ms and 200 ms, for delayed packets to arrive. Other devices utilize adaptive jitter buffers which optimize the delay/discard tradeoff based on network performance parameters (e.g., measured QoS parameters such as delay, traffic, available bandwidth, bandwidth utilization, etc.). In another example, U.S. Patent Publication No. 20080240004, the entire contents of which are hereby incorporated herein by reference, provides a mechanism for dynamically adjusting jitter buffer size based on the duplex mode of a communication channel. All of these prior art devices and system have attempted to optimize the delay/discard network aspects of VoIP performance and have failed to account for conversational dynamics and other settings that are indicative of conversational dynamics.

Accordingly, these and other needs are addressed by embodiments of the present invention. More particularly, methods, devices, and system are provided which optimize jitter buffer size based on conversational dynamics. The conversational dynamics monitored and used to adjust a receiving communication device's jitter buffer size may include user inputs as well as other general system parameters determined by a user. Basing jitter buffer size on these inputs can lead to a more efficient and intelligent balancing of latency and audio quality.

In accordance with at least some embodiments a method is provided that generally comprises:

monitoring at least one parameter indicative of conversational dynamics for a communication session between at least a first and second communication session participant using a first and second communication device, respectively; and

adjusting a capacity of a jitter buffer used in the communication session based on the monitored at least one parameter.

The term “jitter” is an undesirable timing variation in the receipt of a transmitted packetized digital signal.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module”, “agent”, or “tool” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of embodiments of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is block diagram depicting a communication system in accordance with at least some embodiments of the present invention; and

FIG. 2 is a flow diagram depicting a buffer management method in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to balance latency and voice quality in digital telephony systems.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

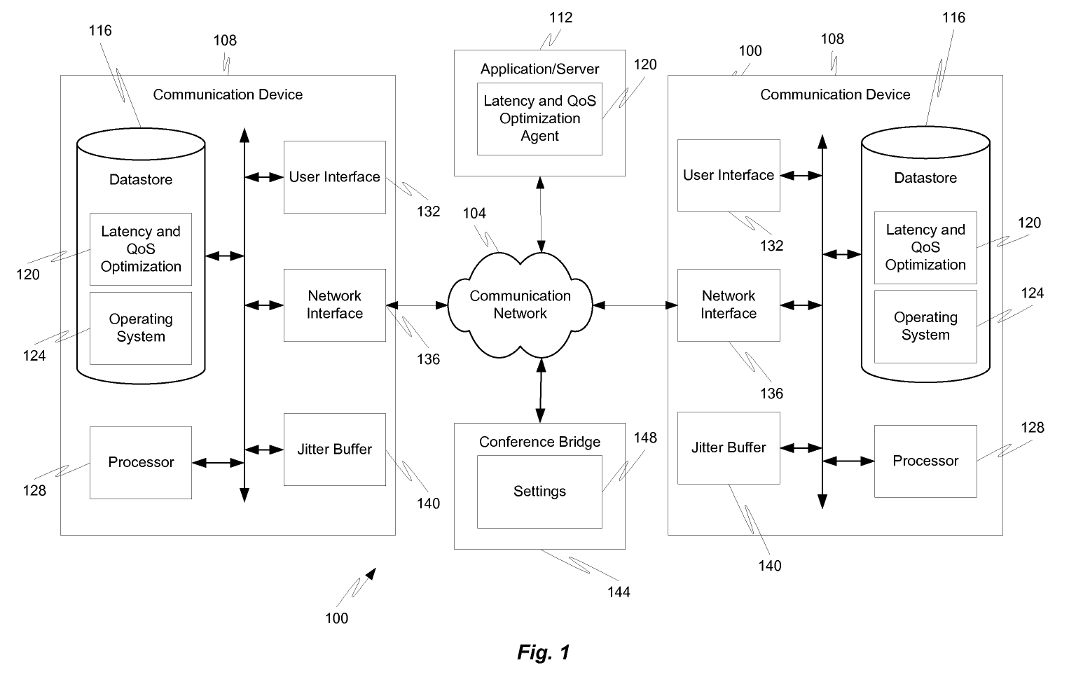

Referring now to FIG. 1, an exemplary communication system 100 is depicted in accordance with at least some embodiments of the present invention. The communication system 100 may comprise a communication network 104 that facilitates communications (e.g., voice, image, video, data, other non-voice media types employing protocols that support conversational text, such as those described in RFC-4103 (RTP Payload for Text Conversation), and combinations thereof) between various communication devices 108. The communications between communication devices 108 may be direct communications or, in some embodiments, may be facilitated by a conference bridge 144.

The communication network 104 may be any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular communication network, a satellite communication network, any type of enterprise network, and any other type of packet-switched or circuit-switched network known in the art. Generally speaking however, the communication network 104 comprises at least one packet-based communication network. In addition, it can be appreciated that the communication network 104 need not be limited to any one network type, and instead may be comprised of a number of different networks and/or network types.

The communication device 108 may be any type of known communication or processing device such as a Digital Control Protocol (DCP) phone, VoIP telephones, Push-To-Talk (PTT) telephony devices, a computer (e.g., personal computer, laptop, or Personal Digital Assistant (PDA)) with a Computer Telephony Interface (CTI), a mobile telephone, a smart phone, or combinations thereof. The communication device 108 may be controlled by or associated with a single user or may be adapted for use by many users (e.g., an enterprise communication device that allows any enterprise user to utilize the communication device upon presentation of a valid user name and password). In general the communication device 108 may be adapted to support video, audio, text, and/or data communications with other communication devices 108. The type of medium used by the communication device 108 to communicate with other communication devices 108 may depend upon the communication applications available on the communication device 108.

One or more of the communication devices 108 may comprise various components that enable it to transmit and receive packets containing voice communication data across the communication network 104. A communication device 108 may, therefore, include a datastore 116 and a processor 128. The datastore 116 may include a number of applications or executable instructions that are readable and executable by the processor 128. For instance, the datastore 116 may include a latency and Quality of Service (QoS) optimization agent 120 and a general operating system 124. The latency and QoS agent 120 is generally operable to monitor conversational dynamics and retrieve inputs associated therewith and control a jitter buffer 140 based on such input. The operating system 124, on the other hand, is a high-level application that allows a user to navigate and access the various other applications and processes stored on the datastore 116.

As noted above, the operation of the jitter buffer 140 may be managed by the latency and QoS optimization agent 120. In accordance with at least some embodiments of the present invention, the size of the jitter buffer 140 may be dynamically adjusted during a communication session by the processor's execution 128 of the latency and QoS optimization agent 120.

The jitter buffer 140 may comprise a number of slots, or addressed memory locations, to receive, store, and properly sequence (by timestamp and/or packet number) data, commonly voice or video data, for subsequent readout and presentation to a user via a user interface 132 (e.g., an audio and/or graphical user interface). The buffer 140 may be a hardware device or software process, depending on the configuration, with a software process being preferred. As noted above, the jitter buffer 140 is dynamic and adaptive, having a variable capacity. The jitter buffer 140 is in a managed memory allocation, under the control of latency and QoS optimization agent 120. The latency and QoS optimization agent 120 is adapted to control the size of the jitter buffer 140 by, for example, the capacity of the jitter buffer 140. As will be appreciated, buffer capacity can be expressed using any suitable metric, such as count of packets, number of memory slots, time units (usually in milliseconds), and the like.

The memory allocated to the jitter buffer 140 can be any suitable type of recordable and readable medium. The buffer may use a partitioned common memory or separate memories, depending on the configuration. Another equivalent alternative would be a dedicated memory block or register under the control of the latency and QoS optimization agent 120. Although the jitter buffer 140 is depicted as being separate from the datastore 116, one skilled in the art will appreciate that the jitter buffer 140 may be located in the datastore 116 or in some other memory location or collection of memory devices associated with the datastore 116.

For buffer management, one or more pointers can be employed. In accordance with at least some embodiments of the present invention, the jitter buffer 140 may have a corresponding pair of read and write pointers. The read pointer points to a last-read packet, or portion thereof, while the write pointer points to a last-written or recorded packet, or portion thereof. Although the entire packet, including the packet header, trailer, and payload, is normally written into a buffer slot, an alternative configuration writes only selected parts of the packet into the slot. An example would be the payload and, commonly, also the packet sequence number or time stamp. A read process (not shown) reads the slot contents while a write process (not shown) writes contents to each slot. In addition to the read and write pointers, the jitter buffer 140 may further comprise pop pointers which point to any out of sequence memory location that is needed to re-sequence out of order packets within the jitter buffer 140.

In addition, the communication device 108 may comprise a network interface 136 that is adapted to connect the communication device 108 to the communication network 104. The network interface 136 may comprise a communication modem, a communication port, or any other type of device adapted to condition packets for transmission across the communication network 104 to a destination communication device 108 as well as condition received packets for processing by the processor 128. Examples of network interfaces 136 include, without limitation, a network interface card, a modem, a wired telephony port, a serial or parallel data port, radio frequency broadcast transceiver, a USB port, or other wired or wireless communication network interfaces.

In addition to considering conversational dynamics based on user input at the communication devices 108 and based on setting of the communication devices 108, the latency and QoS optimization agent 120 may be adapted to consider the settings of other devices in the communication system 100. For example, if the communication devices 108 are in communication via a conference bridge 144, then the latency and QoS optimization agent 120 may be adapted to consider conference bridge settings 148 when managing the jitter buffer 140. As one example, if the conference bridge settings 148 indicate that a lecture mode is being used during a conversation (thereby indicating that a one-way communication is being employed), then the jitter buffer 140 may be adjusted to have a larger capacity than if the conference bridge settings 148 indicate that an interactive conversation is in progress.

As can be seen in FIG. 1, the latency and QoS optimization agent 120 may be provided on a user's communication device 108 and/or may be provided as an application operating on a remote server 112. In this particular embodiment, a single latency and QoS optimization agent 120 may be adapted to control the size of multiple jitter buffers 140 of multiple communication devices 108. This may be particularly useful in instances where multiple communication devices 108 are engaged in a single communication session (i.e., in a teleconference). Thus, the remote latency and QoS optimization agent 120 may be adapted to simultaneously control the jitter buffer 140 of many communication devices 108 that are receiving the same or similar audio information.

In accordance with embodiments of the present invention, the server 112 can include interfaces for various other protocols such as a Lightweight Directory Access Protocol (LDAP), H.248, H.323, Simple Mail Transfer Protocol (SMTP), Internet Message Access Protocol 4 (IMAP4), Integrated Services Digital Network (ISDN), E1/T1, and analog line or trunk. The server 112 may also include a PBX, an ACD, an enterprise switch, or other type of communications system switch or server, as well as other types of processor-based communication control devices such as media servers, computers, adjuncts, etc.

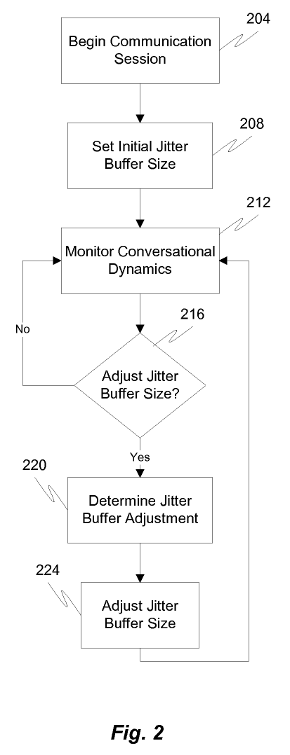

With reference now to FIG. 2, an exemplary jitter buffer management method will be described in accordance with at least some embodiments of the present invention. The method is initiated when a communication session is established between two or more participants and their respective communication devices 108 (step 204). At least one of the communication devices 108 engaged in the communication session may comprise a jitter buffer 140 that is adapted to have its capacity dynamically adjusted based on conversational dynamics.

Initially the size of the jitter buffer 140 is set to a first default size (step 208). This size may correspond to a predetermined jitter buffer size that is based on user preferences or is based on local device settings. As an example, the jitter buffer 140 may be set to have an initial capacity of about 200 ms. This means that the initial latency introduced into the conversation will be about 200 ms.

As the communication session continues, the latency and QoS optimization agent 120 monitors one or more parameters of the communication session that are indicative of conversational dynamics. One concept underlying embodiments of the present invention is that a short-latency jitter buffer 140 is desirable only during highly interactive portions of conversations. Conversely, it makes sense to increase speech quality by lengthening the jitter buffer 140 capacity, thereby increasing latency, when there is a diminished need to accommodate interjections and interruptions. It should be noted, however, that many conversations transition back and forth between conditions in which short latency is desired because the voice path is unidirectional for an extended period of time. The proposed idea, therefore, is to provide the latency and QoS optimization agent 120 with the ability to adjust the capacity of the jitter buffer 140, and thereby adjust the latency period for the communication session, dynamically and mid-call to accommodate current conversational conditions.

Accordingly, the latency and QoS optimization agent 120 may monitor any number of parameters related to conversational dynamics. As one example, the latency and QoS optimization agent 120 may monitor whether a user has engaged a MUTE function on the communication device 108. In this particular example, if the latency and QoS optimization agent 120 determines that the MUTE function is off, then it would determine that jitter buffer latency should be short. This determination can be made because the user has essentially self-identified the need to respond to something that she hears by virtue of keeping the microphone active. By contrast, a user who has engaged the MUTE function is self-identifying as not needing the ability to speak at that moment. If the latency and QoS optimization agent 120 determines that the MUTE function is on, then the capacity of the jitter buffer 140 may be increased. This exchanges the longer jitter buffer latency for higher speech quality. Accordingly, the latency and QoS optimization agent 120 is adapted to monitor the operation of the communication device 108 to determine or speculate that the user would desire an increase in QoS at the expense of increased latency.

As another example, the latency and QoS optimization agent 120 may be adapted to monitor communication session settings. More specifically, if a lecture mode is being employed during a communication session, then the latency and QoS optimization agent 120 may determine that a greater amount of latency can be tolerated. If the mode of the communication session changes to a question and answer portion, then the latency and QoS optimization agent 120 can adjust the capacity of the jitter buffer 140 to compensate for interactive communications. These settings 148 may be selected during conference setup and may be retrieved from the conference bridge 144 at any point before or during the communication session.

Other examples of parameters that may be monitored by the latency and QoS optimization agent 120 include, without limitation, the behavior of a communication session participant, voice activity from one participant, relative voice activity of a participant as compared to other participants, the timing and frequency of participant voice activity, whether a participant is employing a display to stream text from the communication session, whether a participant is placing the communication session on hold periodically, etc.

In a more sophisticated implementation, the latency and QoS optimization agent 120 may be adapted to analyze conversational flow and control the capacity of the jitter buffer 140 accordingly. More particularly, if participants are identified as taking turns speaking frequently (by comparing total voice activity of the participants), interjecting frequently (by analyzing the frequency of voice activity possibly coupled with extended periods of voice activity after an occurrence), or interrupting frequently (by analyzing concurrent voice activity), then the latency and QoS optimization agent 120 may be adapted to automatically adjust the jitter buffer latency to be relatively short. By contrast, if the conversational analysis indicates that the communication flow is unidirectional for extended periods of time (by determining that a ratio of voice activity for one participant as compared to another participant exceeds a predetermined threshold, likely larger than 50%), or if it is observed that participants wait for a speaker to finish a thought before replying, then the latency and QoS optimization agent 120 may be adapted to automatically adjust the jitter buffer latency to be longer.

In another variation, the latency and QoS agent 120 may be adapted to take input from an agenda, a slide deck, a scheduling software application and/or other applications or materials used as a part of the communication session and track the actual advance of the participants through those materials as an indicator of anticipated conversational dynamics to control the capacity of the jitter buffer 140 accordingly. More particularly, if one speaker is identified as presenting the materials in a lecture mode and a Q & A session is shown at the end, it may be assumed at least initially that the interjections and interruptions will be low and are likely to increase once the communication session reaches the Q & A portion of the session. These materials and/or applications may be useful in setting the initial size of the jitter buffer prior to the onset of the communications session.

One or more of the above-described parameters, or similar parameters, may be monitored by the latency and QoS optimization agent 120 during this monitoring phase. As the latency and QoS optimization agent 120 continues to monitor the conversational dynamics of the communication session it may continually determine whether it is necessary or desirable to adjust the size of the jitter buffer 140 (step 216). This determination can be made by periodically checking relevant parameters. Alternatively, this determination may be made if any particular parameter or collection of parameters exceeds a predetermined threshold at any point in time during the communication session. As another alternative it may be made based on a combination of presentation materials and parameter thresholds. Thus, if presentation materials indicate that the presentation begins in a lecture mode and then moves into a Q & A mode, then the latency and QoS optimization agent 120 may check relevant parameters at a first frequency during the first part of the presentation and then check the same relevant parameters (or possibly different parameters) at a second different frequency during the second part of the presentation.

As can be appreciated by one skilled in the art, each of the above-described determination methods are not necessarily exclusive nor exhaustive. For example, one determination method may be combined with another determination method in accordance with at least some embodiments of the present invention. Furthermore, other determination methods not specifically mentioned above can also be used alone or in combination when deciding when to adjust jitter buffer latency.

If the latency and QoS optimization agent 120 does not determine that an adjustment to the jitter buffer 140 is necessary, then the method returns to step 212. If, however, the latency and QoS optimization agent 120 determines that the jitter buffer 140 should be adjusted, then the method continues with the latency and QoS optimization agent 120 determining how the jitter buffer 140 should be adjusted (step 220). In other words, the latency and QoS optimization agent 120 determines whether the capacity of the jitter buffer 140 should be increased or decreased. The latency and QoS optimization agent 120 continues by adjusting the jitter buffer 140 to compensate for the conversational dynamics (step 224).

In accordance with at least some further embodiments of the present invention, the latency and QoS optimization agent 120 may be adapted to progressively and continuously adjust the capacity of the jitter buffer 140. For example, as the latency and QoS optimization agent 120 continues to determine that a communication session is a one-sided communication (i.e., there have been multiple determinations within a predetermined period of time to adjust the jitter buffer 140), then the size of the jitter buffer 140 may jumped to a particular predetermined size rather than relying upon smaller incremental increases in jitter buffer 140 size. Similarly, once the communication session returns to an interactive type of communication session, then the jitter buffer 140 may be reset back to its initial capacity rather than incrementally decreasing the size of the jitter buffer 140.

Embodiments of the present invention can also be applied to multimedia communication sessions or presentations. In such a situation, the latency can be reduced based on presentation content (e.g., slide content). For instance, if the slides indicate that the presenter is entering a question and answer phase of the presentation, then the size of all jitter buffers 140 engaged in the presentation may be reduced to facilitate the interactive discussion. As another example, if a communication session is in lecture mode, a listener may be required to signal to the remote latency and QoS optimization agent 120 (e.g., via a DTMF signal) that they wish to ask a question. The latency and QoS optimization agent 120 can respond to this request by adjusting the jitter buffers 140 of any other participant to the communication session.

Other factors may also be considered when adjusting the capacity of the jitter buffer 140. For example, the latency and QoS optimization agent 120 may also consider the capabilities (e.g., wired vs. wireless capabilities) and functionality of a communication device 108 when determining if and how much a particular jitter buffer 140 should be adjusted.

Additionally, although embodiments of the present invention may be particularly useful when applied to systems employing packet loss concealment mechanisms, embodiments of the present invention may also be utilized in systems where TCP is used (i.e., in systems that request a retransmission if a packet is determined to be missing).

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication and computer arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into software and/or hardware system, such as the hardware and software systems of a communications device or system.

It is therefore apparent that there has been provided, in accordance with the present invention, systems, apparatuses and methods for managing jitter buffer capacity. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
monitoring at least one parameter indicative of conversational dynamics for a communication session between at least a first and second communication session participant using a first and second communication device, respectively; and
adjusting a capacity of a jitter buffer used in the communication session based on the monitored at least one parameter.

2. The method of claim 1, wherein the monitored at least one parameter comprises a user input from one or more of the participants.

3. The method of claim 2, wherein the user input comprises voice activity and wherein a relative voice activity of the first participant as compared to at least the second participant is used as a basis for adjusting the capacity of the jitter buffer.

4. The method of claim 2, wherein the user input comprises a system setting configured by a user in connection with the communication session.

5. The method of claim 2, wherein the user input comprises a user selection entered at a communication device indicating a particular communication feature is desired.

6. The method of claim 5, wherein the communication feature comprises a mute feature.

7. The method of claim 1, wherein the at least one parameter comprises one or more of the following: (i) a behavior of the first participant, (ii) a behavior of the second participant, (iii) voice activity of a participant, (iv) relative voice activity of a participant as compared to other participants, (v) timing of participant voice activity, (vi) frequency of participant voice activity, (vii) whether a participant is employing a display to stream text from the communication session, (viii) whether a participant is placing the communication session on hold periodically, and (ix) anticipated behaviors based on materials related to the communication session.

8. The method of claim 1, wherein the jitter buffer is initially set at a first capacity, the method further comprising:
determining that the communication session interactivity is increasing; and
in response to determining that the communication session interactivity is increasing, adjusting the capacity of the jitter buffer to a second capacity that is smaller than the first capacity.

9. The method of claim 1, wherein the jitter buffer is initially set at a first capacity, the method further comprising:
determining that the communication session interactivity is decreasing; and
in response to determining that the communication session interactivity is decreasing, adjusting the capacity of the jitter buffer to a second capacity that is larger than the first capacity.

10. The method of claim 1, wherein the jitter buffer is initially set at a first capacity and wherein adjusting the jitter buffer capacity comprises changing the capacity of the jitter buffer to a second capacity during the communication session, wherein the second capacity is different from the first capacity.

11. The method of claim 10, further comprising adjusting the jitter buffer capacity from the second capacity to a third capacity during the communication session, wherein the third capacity is different from the first and second capacities.

12. A computer readable medium encoded with processor executable instructions operable to, when executed, perform the method of claim 1.

13. A communication device, comprising:
a jitter buffer adapted to collect data packets from a communication session; and
a latency and QoS optimization agent operable to monitor at least one parameter indicative of conversational dynamics for the communication session and adjust a capacity of the jitter buffer based on the monitored at least one parameter.

14. The device of claim 13, wherein the monitored at least one parameter comprises a user input from a participant of the communication session.

15. The device of claim 14, wherein the user input comprises voice activity and wherein a relative voice activity of a first participant as compared to at least a second participant is used as a basis for adjusting the capacity of the jitter buffer.

16. The device of claim 14, wherein the user input comprises a system setting configured by a user in connection with the communication session.

17. The device of claim 14, wherein the user input comprises a user selection entered at a communication device indicating a particular communication feature is desired.

18. The device of claim 17, wherein the communication feature comprises a mute feature.

19. The device of claim 13, wherein the at least one parameter comprises one or more of the following: (i) a behavior of a participant, (ii) voice activity of a participant, (iii) relative voice activity of a participant as compared to other participants, (iv) timing of participant voice activity, (v) frequency of participant voice activity, (vi) whether a participant is employing a display to stream text from the communication session, (vii) whether a participant is placing the communication session on hold periodically, and (viii) anticipated behaviors based on materials related to the communication session.

20. The device of claim 13, wherein the jitter buffer is initially set at a first capacity, and the latency and QoS optimization agent is further operable to determine that the communication session interactivity is increasing and, in response to determining that the communication session interactivity is increasing, adjust the capacity of the jitter buffer to a second capacity that is smaller than the first capacity.

21. The device of claim 13, wherein the jitter buffer is initially set at a first capacity and wherein the latency and QoS optimization agent is further operable to adjust the jitter buffer capacity to a second capacity during the communication session, wherein the second capacity is different from the first capacity.

22. The device of claim 21, wherein the latency and QoS optimization agent is further operable to adjust the jitter buffer capacity from the second capacity to a third capacity during the communication session, wherein the third capacity is different from the first and second capacities.

23. A communication system, comprising:
a communication device adapted to receive data packets in connection with a communication session, the communication device comprising a jitter buffer for managing and organizing the received data packets; and
a latency and QoS optimization agent operable to monitor at least one parameter indicative of conversational dynamics for the communication session and adjust a capacity of the jitter buffer based on the monitored at least one parameter.

24. A system of claim 23, wherein the latency and QoS optimization agent does not reside on the communication device.
